(19) United States
(12) Patent Application Publication
(10) Pub. No.: US 2024/0211803 A1
(43) Pub. Date: Jun. 27, 2024

(54) METHOD AND ELECTRONIC SYSTEM FOR PREDICTING VALUE(S) OF A QUANTITY RELATIVE TO A DEVICE, RELATED OPERATING METHOD AND COMPUTER PROGRAM

(71) Applicants: TotalEnergies One Tech, COURBEVOIE (FR); Centre national de la recherche scientifique, Paris (FR); ECOLE POLYTECHNIQUE, PALAISEAU (FR)

(72) Inventors: Antoine BERTONCELLO, PAU CEDEX (FR); Naoufal ACHARKI, PAU CEDEX (FR); Josselin GARNIER, PALAISEAU CEDEX (FR)

(73) Assignees: TotalEnergies OneTech, COURBEVOIE (FR); Centre national de la recherche scientifique, PARIS (FR); ECOLE POLYTECHNIQUE, PALAISEAU (FR)

(21) Appl. No.: 18/288,881

(22) PCT Filed: May 6, 2021
(86) PCT No.: PCT/IB2021/000377

§ 371 Date: Oct. 30, 2023

(51) Int. Cl. G06N 20/00; G06N 7/01

(52) U.S. Cl. CPC G06N 20/00; G06N 7/01

(57) ABSTRACT

This method for predicting value(s) of a quantity relative to a target device is implemented by an electronic prediction system and comprises the following steps:
training a prediction probabilistic model, said training including:
   receiving measured values of the quantity for N devices, N>1,
   calculating predicted values of the quantity for said N devices with the prediction probabilistic model,
   computing a criteria based on the measured values and on the predicted values,
   modifying model parameter(s) of the prediction probabilistic model according to the computed criteria,
   updating the prediction probabilistic model with the modified model parameter(s),
predicting value(s) of the quantity relative to the target device with the trained prediction probabilistic model;
wherein the criteria depends on a predefined distribution quantile.

### CROSS REFERENCE TO RELATED APPLICATION

The present application is a U.S. National Phase Application under 37 C.F.R. § 371 of International Patent Application No. PCT/IB2021/000377 filed May 6, 2021. The entire contents of which is hereby incorporated by reference.

### FIELD OF THE INVENTION

The present invention relates to a method for predicting value(s) of a quantity relative to a target device, the method being implemented by an electronic prediction system.

The invention also relates to a method for operating a device with predicted value(s) of a quantity relative to said device, the predicted value(s) being obtained with such a prediction method.

The invention also relates to a non-transitory computer-readable medium including a computer program including software instructions which, when executed by a processor, implement such a prediction method or such an operating method.

The invention also relates to an electronic prediction system for predicting value(s) of a quantity relative to a target device.

### BACKGROUND

The invention concerns particularly the field of operating industrial devices, such as an oil and/or gas production well or an electric battery, with predicted value(s) of a quantity relative to said respective devices, and the field of prediction methods for predicting such value(s) of the quantity.

For an oil and/or gas production well, the quantity is for example a production quantity, such as a cumulated production over a predefined duration. For an electric battery, the quantity is for example a number of load cycles up to a predefined loss of battery capacity.

Current learning models are not always capable of quantifying uncertainties in data and issuing prediction intervals that meet a required confidence level.

Many approaches of supervised learning focus on point prediction by producing a single value for a new point and do not provide information about how far those predictions may be from true response values. This may be inadmissible, especially for systems that require risk management. Indeed, an interval may be important and may offer valuable information that helps for better management than just predicting a single value.

The prediction intervals are well-known tools to provide more information by quantifying and representing a level of uncertainty associated with predictions. One existing and popular approach for prediction models without predictive distribution (e.g. Random Forest or Gradient Boosting) is the bootstrap, starting from a traditional bootstrap presented in article “An Introduction to the Bootstrap” from B. Efron and R. J. Tibshirani, 1994 or in article “Practical confidence and prediction intervals” from T. Heskes, 1997, to an improved bootstrap, presented in article “Interval prediction of solar power using an improved bootstrap method” from K. Li et al., 2018.

The bootstrap is one of the most used methods for estimating empirical variances and for constructing predictions intervals, and it is claimed to achieve good performance under some asymptotic framework.

Probabilistic regression models typically use the maximum likelihood estimation (MLE) to fit parameters.

However, the Maximum Likelihood Estimation may give advantage to solutions that fit observations in average, without paying attention to the coverage and the width of prediction intervals.

### SUMMARY

An object of the invention is therefore to provide a method and an associated electronic system for predicting value(s) of a quantity relative to a device, which allows providing better prediction intervals.

For this purpose, the subject-matter of the invention is a method for predicting value(s) of a quantity relative to a target device, the method being implemented by an electronic prediction system and comprising the following steps:
training a prediction probabilistic model, said training including the following sub-steps:
   receiving measured values of the quantity for N devices, N being an integer strictly greater than 1,
   calculating predicted values of the quantity for said N devices with the prediction probabilistic model,
   computing a criteria based on the measured values and on the predicted values,
   modifying model parameter(s) of the prediction probabilistic model according to the computed criteria,
   updating the prediction probabilistic model with the modified model parameter(s),
predicting value(s) of the quantity relative to the target device with the trained prediction probabilistic model;
wherein the criteria depends on a predefined distribution quantile.

Thus, by taking into account the predefined distribution quantile into the criteria used for optimizing the model parameter(s) of the prediction probabilistic model, also called hyperparameter(s), the method according to the invention allows building a prediction model capable of accurately predicting quantiles and of giving prediction intervals that incorporate the uncertainties of the data.

Preferably, the model parameter(s) are determined via a cross-validation process.

Still preferably, these model parameter(s) are relaxed by choosing the parameters that minimize a distance, such as the Wasserstein distance, between a covariance matrix of a set of reference parameters and a covariance matrix of the set of parameters that verifies the criteria. The reference parameters are typically obtained using a maximum likelihood estimation or according to a mean square error criteria.

According to other advantageous aspects of the invention, the prediction method comprises one or several of the following features, taken individually or according to any technically possible combination:
the calculating sub-step is carried out according to a cross-validation process;
when the prediction probabilistic model is a model chosen among a Gaussian process model and a linear regression model, the predefined distribution quantile is the A-quantile of the standard normal law, A being a real number belonging to the interval [0; 1];
the cross-validation process is a Leave-One-Out Cross Validation process, and the criteria further depends on a Leave-One-Out mean of the predicted values and on a Leave-One-Out standard deviation of the predicted values;
when the prediction probabilistic model is the Gaussian process model, the criteria verifies the following equation:

$${ψ}_{A} ( {σ}^{2} , θ ) = A$$

where A is a real number belonging to the interval [0; 1],
σ, θ represent the model parameters of the prediction probabilistic model, and
Ψ_{A} is a quasi-Gaussian proportion verifying the following equation:

$${ψ}_{A} ( {σ}^{2} , θ ) = \frac{1}{N} {\sum }_{k = 1}^{N} 𝕝 ( \frac{{y}_{k} -}{} \leq {q}_{A} )$$

where N represent the number of devices for which measured values of the quantity have been received, N being an integer strictly greater than 1,
[symbol] represents the indicator function indicating 1 if the inequality holds or 0 if not,
yₖ represent the measured values of the quantity, k being an index between 1 and N,
[symbol] and [symbol] represent respectively the Leave-One-Out mean of the predicted values and the Leave-One-Out standard deviation of the predicted values, and
q_{A} is the A-quantile of the standard normal law;
when the prediction probabilistic model is the linear regression model, the criteria verifies the following equation:

$${ψ}_{A} ( β ) = A$$

where A is a real number belonging to the interval [0; 1],
β represents the regression model's parameters, and
Ψ_{A} is a quasi-Gaussian proportion verifying the following equation:

$${ψ}_{A} ( β ) = \frac{1}{N} {\sum }_{k = 1}^{N} 𝕝 ( \frac{{y}_{k} -}{} \leq {q}_{A} )$$

where N represent the number of devices for which measured values of the quantity have been received, N being an integer strictly greater than 1,
[symbol] represents the indicator function indicating 1 if the inequality holds or 0 if not,
yₖ represent the measured values of the quantity, k being an index between 1 and N,
[symbol] and [symbol] represent respectively the Leave-One-Out mean of the predicted values and the Leave-One-Out standard deviation of the predicted values, and
q_{A} is the A-quantile of the standard normal law;
the training step further comprises a sub-step of determining reference parameter(s) of the prediction probabilistic model according to an error criteria, such as a Mean Square Error criteria or a Mean Absolute Error criteria;
the training step further comprises a sub-step of evaluating a distance between the reference parameter(s) and the model parameter(s);
the distance being preferably the Wasserstein distance when the prediction probabilistic model is a Gaussian process model;
the distance being preferably the Euclidean distance when the prediction probabilistic model is a linear regression model;
the training step further comprises a sub-step of minimizing said distance by solving a relaxed optimization problem;
when the prediction probabilistic model is the Gaussian process model, the relaxed optimization problem preferably verifying the following equation:

$${P}_{λ} : arg {min}_{λ} {Π}^{2} ( {K}_{0} , K ( {σ}_{A}^{2} ( λ ) , λ {θ}_{0} ) )$$

where λ is an optimization parameter,
π represents the Wasserstein distance,
K₀ represents a covariance matrix of the reference parameters, and
K represents a covariance matrix of the model parameters (σ_{A}, λθ₀) obtained according to the computed criteria;
when the prediction probabilistic model is the linear regression model, the relaxed optimization problem preferably verifying the following equation:

$${P}_{λ} : arg {min}_{λ} {d}^{2} ( {β}_{0} , λ β )$$

where λ is an optimization parameter,
d represents the Euclidean distance,
β₀ represents the reference regression model's parameters, and
β represents the regression model's parameters obtained according to the computed criteria;
the updating sub-step is carried out with the optimization parameter and the model parameters obtained further to the solved relaxed optimization problem;
each device is subject to aging, and the quantity depends of the age of the device;
each device being preferably of the type chosen from among the group consisting of: an oil and/or gas production well, an electric battery, a dielectric insulation for an electric cable;
the N devices are of the same type than the target device;
when each device is an oil and/or gas production well, the quantity is a production quantity, such as a cumulated production over a predefined duration,
when each device is an electric battery, the quantity is a number of load cycles up to a predefined loss of battery capacity,
when each device is a dielectric insulation for an electric cable, the quantity is a dielectric rigidity.

The subject-matter of the invention is also a method for operating a device with predicted value(s) of a quantity relative to said device, the predicted value(s) being obtained with a prediction method as defined above.

The subject-matter of the invention is also a non-transitory computer-readable medium including a computer program including software instructions which, when executed by a processor, implement a prediction method as defined above or an operating method as defined above.

The subject-matter of the invention is also an electronic prediction system for predicting value(s) of a quantity relative to a target device, the system comprising:
a training module configured for training a prediction probabilistic model, the training module including:
   a receiving unit configured for receiving measured values of the quantity for N devices, N being an integer strictly greater than 1,
   a calculating unit configured for calculating predicted values of the quantity for said N devices with the prediction probabilistic model,
   a computing unit configured for computing a criteria based on the measured values and on the predicted values,
   a modifying unit configured for modifying model parameter(s) of the prediction probabilistic model according to the computed criteria,
   an updating unit configured for updating the prediction probabilistic model with the modified model parameter(s),
a predicting module configured for predicting value(s) of the quantity relative to the target device with the trained prediction probabilistic model;
wherein the criteria depends on a predefined distribution quantile.

### BRIEF DESCRIPTION OF THE DRAWINGS

The invention will be better understood upon reading of the following description, which is given solely by way of example and with reference to the appended drawings, wherein:

FIG. 1 is a schematic view of an electronic prediction system for predicting value(s) of a quantity relative to a target device, the system comprising a training module for training a prediction probabilistic model and a predicting module for predicting value(s) of the quantity relative to the target device with the trained prediction model; said training module including a receiving unit for receiving measured values of the quantity for N devices, a calculating unit for calculating predicted values of the quantity for said N devices with the prediction probabilistic model, a computing unit for computing a criteria based on the measured values and on the predicted values, a modifying unit for modifying model parameter(s) of the prediction probabilistic model according to the computed criteria, an updating unit for updating the prediction probabilistic model with the modified model parameter(s);

FIG. 2 is a view illustrating a relaxation effect on an estimated cumulative distribution function of a Leave-One-Out standardized predictive distribution on a quantile of level equal to 95%, with a curve in mixed line representing a standard normal law predictive distribution, a curve in solid line representing a Maximum Likelihood Estimation (MLE) standardized predictive distribution and a curve in dotted line representing a standardized predictive distribution after relaxing model parameters; the relaxed standardized predictive distribution coinciding with the standard normal law distribution on point (q_{0.95}, 0.95) instead of (Ψ_{0.95}, 0.95);

FIG. 3 is a flowchart of a method for operating the target device of FIG. 1 with predicted value(s) of the quantity relative to said device, the predicted value(s) being obtained with a prediction method according to the invention, the prediction method being implemented by the electronic prediction system of FIG. 1;

FIG. 4 is a view illustrating the results obtained with a prior art method with a MLE standardized predictive distribution, when the device is an oil and/or gas production well, and the quantity is a cumulated production over a predefined duration;

FIG. 5 is a view similar to the one of FIG. 4 with the method according to the invention;

FIG. 6 is a view illustrating the results obtained with a prior art method with a MLE standardized predictive distribution, when the device is an electric battery and the quantity is a number of load cycles up to a predefined loss of battery capacity; and

FIG. 7 is a view similar to the one of FIG. 6 with the method according to the invention.

### DETAILED DESCRIPTION

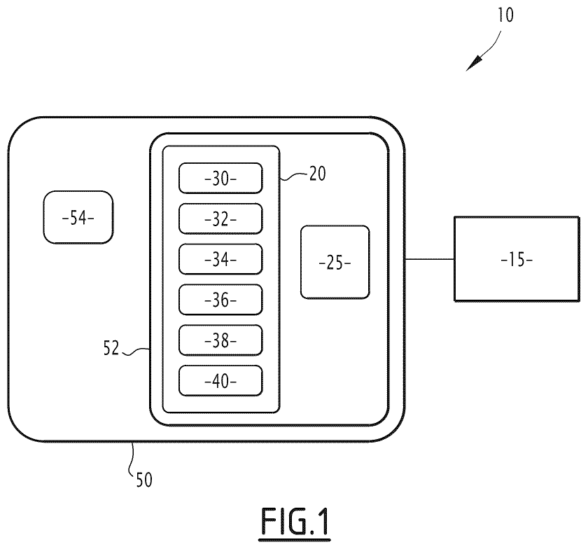

In FIG. 1, an electronic prediction system 10 is configured for predicting value(s) of a quantity relative to a target device 15. The electronic prediction system 10 comprises a training module 20 for training a prediction probabilistic model and a predicting module 25 for predicting value(s) of the quantity relative to the target device 15 with the trained prediction probabilistic model.

The electronic prediction system 10 is further configured to transmit the predicted value(s) of the quantity to the target device 15 or to a control system, not shown, for controlling the target device 15, so as to operate the device 15 with said predicted value(s) of the quantity.

The target device 15 is subject to aging, and the quantity depends of the age of the device 15.

The target device 15 is for example of the type chosen from among the group consisting of: an oil and/or gas production well, an electric battery, a dielectric insulation for an electric cable.

When the target device 15 is an oil and/or gas production well, the quantity is for example a production quantity, such as a cumulated production over a predefined duration.

When the target device 15 is an electric battery, the quantity is typically a number of load cycles up to a predefined loss of battery capacity.

When the target device 15 is a dielectric insulation for an electric cable, the quantity is for example a dielectric rigidity.

The training module 20 is configured for training the prediction probabilistic model. The prediction probabilistic model is for example a Gaussian Process model. As a variant, the prediction probabilistic model is a linear regression model.

The training module 20 includes a receiving unit 30 for receiving measured values of the quantity for N devices, a calculating unit 32 for calculating predicted values of the quantity for said N devices with the prediction probabilistic model, a computing unit 34 for computing a criteria based on the measured values and on the predicted values, a modifying unit 36 for modifying model parameter(s) of the prediction probabilistic model according to the computed criteria, and an updating unit 38 for updating the prediction probabilistic model with the modified model parameter(s).

In optional addition, the training module 20 includes a determining unit 40 for determining reference parameter(s) of the prediction probabilistic model according to an error criteria.

The predicting module 25 is configured for predicting value(s) of the quantity relative to the target device 15 with the prediction probabilistic model previously trained by the training module 20.

In the example of FIG. 1, the electronic prediction system 10 includes a processing unit 50 formed for example of a memory 52 and of a processor 54 coupled to the memory 52. In this example, the electronic prediction system 10 also includes a display screen and input/output means, not shown, such as a keyboard and a mouse, each being connected to the processing unit 50.

In the example of FIG. 1, the training module 20 and the predicting module 25 are for example each realized, i.e. implemented, as a software executable by the processor 54. Accordingly, the receiving unit 30, the calculating unit 32, the computing unit 34, the modifying unit 36 and the updating unit 38, and also in optional addition the determining unit 40, are each realized, i.e. implemented, as a software executable by the processor 54. The memory 52 of the processing unit 50 is adapted to store a training software for training the prediction probabilistic model and a predicting software for predicting value(s) of the quantity relative to the target device 15 with the trained prediction probabilistic model. In addition, The memory 52 of the processing unit 50 is adapted to store a receiving software for receiving the measured values of the quantity for the N devices, a calculating software for calculating the predicted values of the quantity for said N devices with the prediction probabilistic model, a computing software for computing the criteria based on the measured values and on the predicted values, a modifying software for modifying the model parameter(s) of the prediction probabilistic model according to the computed criteria, and an updating software for updating the prediction probabilistic model with the modified model parameter(s). In optional addition, the memory 52 of the processing unit 50 is adapted to store a determining software for determining the reference parameter(s) of the prediction probabilistic model according to the error criteria. The processor 54 of the processing unit 50 is then configured to execute the training software, the predicting software, and in addition the receiving software, the calculating software, the computing software, the modifying software and the updating software, and also in optional addition the determining software.

As a variant not shown, the training module 20 and the predicting module 25, the receiving unit 30, the calculating unit 32, the computing unit 34, the modifying unit 36 and the updating unit 38, and also in optional addition the determining unit 40, are each in the form of a programmable logic component, such as a Field Programmable Gate Array or FPGA, or in the form of a dedicated integrated circuit, such as an Application Specific integrated Circuit or ASIC.

When the electronic prediction system 10 is in the form of one or more software programs, i.e. in the form of a computer program, it is also capable of being recorded on a computer-readable medium, not shown. The computer-readable medium is, for example, a medium capable of storing electronic instructions and being coupled to a bus of a computer system. For example, the readable medium is an optical disk, a magneto-optical disk, a ROM memory, a RAM memory, any type of non-volatile memory (for example EPROM, EEPROM, FLASH, NVRAM), a magnetic card or an optical card. A computer program with software instructions is then stored on the readable medium.

The receiving unit 30 is configured for receiving measured values of the quantity for the N devices, N being an integer strictly greater than 1. The N devices are typically of the same type than the target device 15. In other words, the receiving unit 30 is configured for acquiring the measured values of the quantity for the N devices, for example from sensors and/or a database, not shown.

The calculating unit 32 is configured for calculating the predicted values of the quantity for said N devices with the prediction probabilistic model. The calculating unit 32 is typically configured for calculating the predicted values of the quantity for said N devices according to a cross-validation process. The cross-validation process is for example a Leave-One-Out Cross Validation process, also called LOOCV process.

The computing unit 34 is configured for computing the criteria based on the measured values received by the receiving unit 30 and on the predicted values calculated by the calculating unit 32.

According to the invention, the criteria depends on a predefined distribution quantile q_{A} and the computing unit 34 is configured for computing the criteria according to said predefined distribution quantile q_{A}.

The predefined distribution quantile q_{A} is for example the A-quantile of the standard normal law, A being a real number belonging to the interval [0; 1].

When—as a variant—the prediction probabilistic model is the linear regression model, the predefined distribution quantile is also the A-quantile of the standard normal law.

In optional addition, when cross-validation process is the Leave-One-Out Cross Validation process, the computing unit 34 is configured for computing the criteria further according to a Leave-One-Out mean of the predicted values and according to a Leave-One-Out standard deviation of the predicted values. In other words, the criteria further depends on the Leave-One-Out mean of the predicted values and on the Leave-One-Out standard deviation of the predicted values.

According to this optional addition, the computing unit 34 is for example configured for computing the criteria according to the following equation:

$${ψ}_{A} ( {σ}^{2} , θ ) = A \qquad ( 1 )$$

where A is a real number belonging to the interval [0; 1],
σ², θ represent the model parameters of the prediction probabilistic model, and
Ψ_{A} is a quasi-Gaussian proportion verifying the following equation:

$${ψ}_{A} ( {σ}^{2} , θ ) = \frac{1}{N} {Σ}_{k = 1}^{N} 𝕝 ( \frac{{y}_{k} -}{} \leq {q}_{A} ) \qquad ( 2 )$$

where N represent the number of devices for which measured values of the quantity have been received, N being an integer strictly greater than 1,
[symbol] represents the indicator function indicating 1 if the inequality holds or 0 if not,
yₖ represent the measured values of the quantity, k being an index between 1 and N,
[symbol] and [symbol] represent respectively the Leave-One-Out mean of the predicted values and the Leave-One-Out standard deviation of the predicted values, and
q_{A} is the A-quantile of the standard normal law.

When—as a variant—the prediction probabilistic model is the linear regression model, equations similar to the above equations (1) and (2) are applicable with respect to linear regression model's parameters. Accordingly, the computing unit 34 is for example configured for computing the criteria according to the following equation:

$${ψ}_{A} ( β ) = A \qquad ( 3 )$$

where A is a real number belonging to the interval [0; 1],
β represents the regression model's parameters (i.e. regression coefficients), and
Ψ_{A} is a quasi-Gaussian proportion verifying the following equation:

$${ψ}_{A} ( β ) = \frac{1}{N} {Σ}_{k = 1}^{N} 𝕝 ( \frac{{y}_{k} -}{} \leq {q}_{A} ) \qquad ( 4 )$$

where N represent the number of devices for which measured values of the quantity have been received, N being an integer strictly greater than 1,
[symbol] represents the indicator function indicating 1 if the inequality holds or 0 if not,
yₖ represent the measured values of the quantity, k being an index between 1 and N,
[symbol] and [symbol] represent respectively the Leave-One-Out mean of the predicted values and the Leave-One-Out standard deviation of the predicted values, and
q_{A} is the A-quantile of the standard normal law.

The modifying unit 36 is configured for modifying the model parameter(s) of the prediction probabilistic model according to the computed criteria. The model parameters of the prediction probabilistic model are for example an amplitude σ² and a length-scale θ, and are also called hyperparameters, in the case of the Gaussian Processes model, each component of the length-scale vector θ is related to a variable of the data, while the amplitude σ² is related to the model.

In optional addition, when the reference parameter(s) of the prediction probabilistic model are determined by the determining unit 40, the modifying unit 36 is further configured for evaluating a distance between the reference parameter(s) and the model parameter(s).

According to this optional addition and when the prediction probabilistic model is the Gaussian process model, the distance is for example the Wasserstein distance.

When—as a variant—the prediction probabilistic model is the linear regression model, the distance is for example the Euclidean distance.

In further optional addition, the modifying unit 36 is further configured for minimizing said distance by solving a relaxed optimization problem P_{λ}.

According to this further optional addition, the modifying unit 36 is for example configured for solving the relaxed optimization problem P_{λ} according to the following equation:

$${P}_{λ} : arg {min}_{λ} {Π}^{2} ( {K}_{0} , K ( {σ}_{A}^{2} ( λ ) , λ {θ}_{0} ) ) \qquad ( 5 )$$

where λ is an optimization parameter,
π represents the Wasserstein distance,
K₀ represents a covariance matrix of the reference parameters, and
K represents a covariance matrix of the model parameters σ_{A}, λθ₀ obtained according to the computed criteria.

When—as a variant—the prediction probabilistic model is the linear regression model, an equation similar to the above equation (5) is applicable. Accordingly, the modifying unit 36 is for example configured for solving the relaxed optimization problem P_{λ} according to the following equation:

$${P}_{λ} : arg {min}_{λ} {d}^{2} ( {β}_{0} , λ β ) \qquad ( 6 )$$

where λ is an optimization parameter,
d represents the Euclidean distance,
β₀ represents the reference regression model's parameters, and
β represents the regression model's parameters obtained according to the computed criteria.

The covariance matrix K₀ of the reference parameters is for example a MLE covariance matrix or a Cross Validation covariance matrix. Similarly, the covariance matrix K of the model parameters σ_{A}, λθ₀ is for example a MLE covariance matrix or a Cross Validation covariance matrix. The distance, such as the Wasserstein distance, forms furthermore a similarity measure.

The updating unit 38 is configured for updating the prediction probabilistic model with the modified model parameter(s).

According to the aforementioned further optional addition, the updating unit 38 is for example configured for updating the prediction probabilistic model with the optimization parameter λ and the model parameters σ_{A}, λθ₀ obtained further to the solved relaxed optimization problem P_{λ}.

In optional addition, the determining unit 40 is configured for determining the reference parameter(s) of the prediction probabilistic model according to the error criteria. The error criteria is typically a Mean Square Error criteria or a Mean Absolute Error criteria.

In the case of the Leave-One-Out process, a Mean Squared prediction Error verifies for example the following equation:

$${LOO}_{M S E} ( {σ}^{2} , θ ) = \frac{1}{N} {\sum }_{k = 1}^{N} {( {y}_{k} - )}^{2} \qquad ( 7 )$$

where σ², θ represent the model parameters of the prediction probabilistic model,
N represent the number of devices for which measured values of the quantity have been received, N being an integer strictly greater than 1,
yₖ represent the measured values of the quantity, k being an index between 1 and N,
[symbol] represent the Leave-One-Out mean of the predicted values.

The Mean Absolute prediction Error verifies for example the following equation:

$${LOO}_{M A E} ( {σ}^{2} , θ ) = \frac{1}{N} {\sum }_{k = 1}^{N} \vert {y}_{k} - \vert \qquad ( 8 )$$

When—as a variant—the prediction probabilistic model is the linear regression model, the above equations (7) and (8) are also applicable with respect to linear regression model's parameter β. Accordingly, a Mean Squared prediction Error verifies for example the following equation:

$${LOO}_{M S E} ( β ) = \frac{1}{N} {\sum }_{k = 1}^{N} {( {y}_{k} - )}^{2} \qquad ( 9 )$$

where σβ represents the regression model's parameters (i.e. regression coefficients),
N represent the number of devices for which measured values of the quantity have been received, N being an integer strictly greater than 1,
yₖ represent the measured values of the quantity, k being an index between 1 and N,
[symbol] represent the Leave-One-Out mean of the predicted values.

The Mean Absolute prediction Error verifies for example the following equation:

$${LOO}_{M A E} ( β ) = \frac{1}{N} {\sum }_{k = 1}^{N} \vert {y}_{k} - \vert \qquad ( 10 )$$

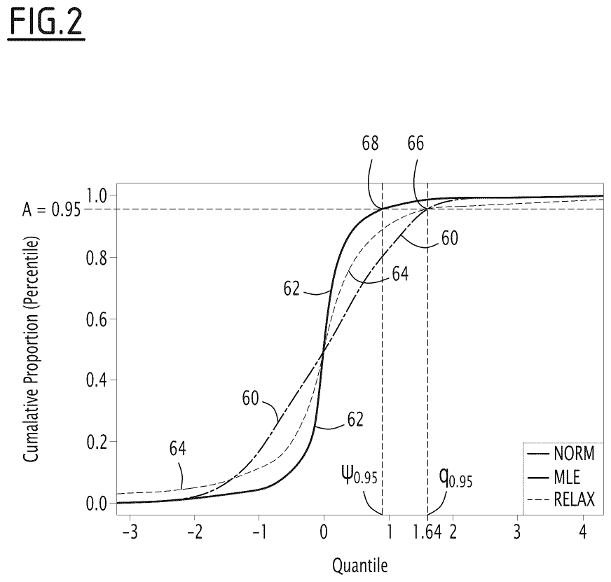

In the example of FIG. 2, a first curve 60 in mixed line represents the standard normal law predictive distribution, also labeled NORM; a second curve 62 in solid line represents the Maximum Likelihood Estimation (MLE) standardized predictive distribution, also labeled MLE; and a third curve 64 in dotted line represents the standardized predictive distribution after relaxing model parameters, said distribution being also labeled RELAX.

FIG. 2 shows the relaxation effect on the estimated cumulative distribution function of the Leave-One-Out standardized predictive distribution on the A-quantile as the relaxed standardized predictive distribution (represented by the third curve 64) coincides with the standard normal law distribution (represented by the first curve 60) on a first point 66 corresponding to (q_{A}, A) with the abscissa equal to the A-quantile q_{A} of the standard normal law and the ordinate equal to the real number A instead of a second point 68 corresponding to (Ψ_{A}, A) with the abscissa equal to the quasi-Gaussian proportion Ψ_{A} and the ordinate equal to the real number A. In the example of FIG. 2, the real number A is equal to 0.95, i.e. to 95%.

The skilled person will therefore observe that when the prediction probabilistic model is the Gaussian Process model, the predictive distribution is Gaussian, and for each level A, i.e. for each value of the real number A, the Leave-One-Out (LOO) method allows defining a similar empirical probability, namely the quasi-Gaussian proportion Ψ_{A}, also called quasi-Gaussian percentile Ψ_{A}, with respect to the A-quantile q_{A} of the standard normal law, also called normal law quantile q_{A}. The quasi-Gaussian proportion Ψ_{A}, describes how close is the real number A, also called percentile A, to the A-quantile q_{A} of the standard normal law.

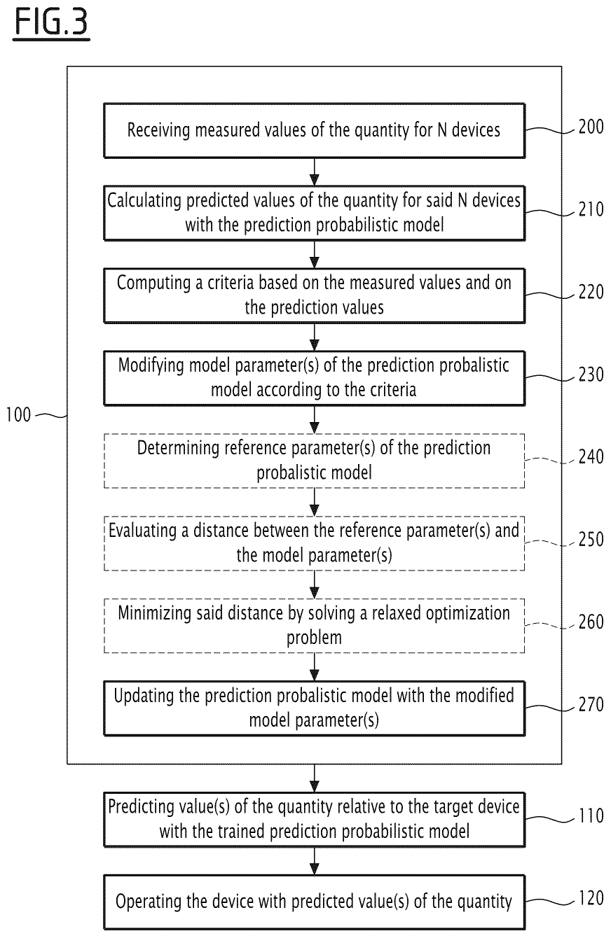

The operation of the electronic prediction system 10 according to the invention will now be explained in view of FIG. 3 representing a flowchart of an operation method according to the invention for operating the target device 15 with predicted value(s) of the quantity relative to said device 15, the predicted value(s) being obtained with a prediction method according to the invention, the prediction method being implemented by the electronic prediction system 10.

The prediction method for predicting value(s) of the quantity relative to the target device 15 comprises a training step 100 for training the prediction probabilistic model and then a predicting step 110 for predicting value(s) of the quantity relative to the target device 15 with the trained prediction probabilistic model.

The operation method for operating the target device 15 with predicted value(s) of the quantity relative to said device comprises the training step 100 and the predicting step 110 of the prediction method so as to predict the value(s) of the quantity relative to the target device 15, and further an operating step 120 for operating the target device 15 with the predicted value(s) of said quantity.

During the initial training step 100, the electronic prediction system 10 trains the prediction probabilistic model via its training module 20.

After the initial training step 100, the electronic prediction system 10 predicts, during the next predicting step 110 and via its predicting module 25, value(s) of the quantity relative to the target device 15, said value(s) being predicted with the prediction probabilistic model trained during the initial training step 100.

Lastly, during the operating step 120, the target device 15 is operated with the value(s) of said quantity predicted during the preceding predicting step 110.

In the example of FIG. 3, the initial training step 100 includes an initial sub-step 200 for receiving measured values of the quantity for N devices. During this initial sub-step 200, the receiving unit 30 acquires the measured values of the quantity for the N devices, typically from respective sensors or from a database wherein the values measured by sensors have been stored. The N devices are typically of the same type than the target device 15.

During a next sub-step 210, the electronic prediction system 10 calculates, via its calculating unit 32, predicted values of the quantity for said N devices with the prediction probabilistic model, and typically according to the cross-validation process, such as the Leave-One-Out Cross Validation process.

The electronic prediction system 10 then computes, during a next computing sub-step 220 and via its computing unit 34, the criteria based on the measured values received during the receiving sub-step 200 and on the predicted values calculated during the calculating sub-step 210.

According to the invention, the criteria depends on the predefined distribution quantile q_{A} and the computing unit 34 therefore computes the criteria according to said predefined distribution quantile q_{A}, such as the A-quantile of the standard normal law, with A real number belonging to the interval [0; 1].

In optional addition, when cross-validation process is the Leave-One-Out Cross Validation process, the computing unit 34 computes the criteria further according to the Leave-One-Out mean of the predicted values and according to the Leave-One-Out standard deviation of the predicted values. The computing unit 34 computes for example said criteria according to the equations (1) and (2).

During a next sub-step 230, the electronic prediction system 10 modifies, via its modifying unit 36, the model parameter(s) of the prediction probabilistic model, also called hyperparameter(s), such as the amplitude σ² and the length-scale θ, according to the computed criteria.

Optionally, the electronic prediction system 10 then determines, during a next optional determining sub-step 240 and via its determining unit 40, the reference parameter(s) of the prediction probabilistic model according to the error criteria, such as the Mean Square Error criteria or the Mean Absolute Error criteria.

During this optional determining sub-step 240, the reference parameter(s) are typically determined by minimizing said error criteria, such as the Mean Squared prediction Error according to the equation (4) or the Mean Absolute prediction Error according to the equation (5).

Further optionally, the electronic prediction system 10 then evaluates, during a next optional evaluating sub-step 250 and via its modifying unit 36, the distance between the reference parameter(s) and the model parameter(s), said distance being for example the Wasserstein distance.

Further optionally, the electronic prediction system 10 then minimizes, during a next optional minimizing sub-step 260 and via its modifying unit 36, the distance between the reference parameter(s) and the model parameter(s), by solving the relaxed optimization problem P_{λ}.

During this optional minimizing sub-step 260, the modifying unit 36 solves for example the relaxed optimization problem P_{λ} according to the equation (3).

Finally, during a last sub-step 270 of the training step 100, also called updating sub-step 270, the electronic prediction system 10 updates, via its updating unit 38, the prediction probabilistic model with the modified model parameter(s).

During this updating sub-step 270, the updating unit 38 updates for example the prediction probabilistic model with the optimization parameter λ and the model parameters σ_{A}, λθ₀ obtained further to the solved relaxed optimization problem P_{λ}.

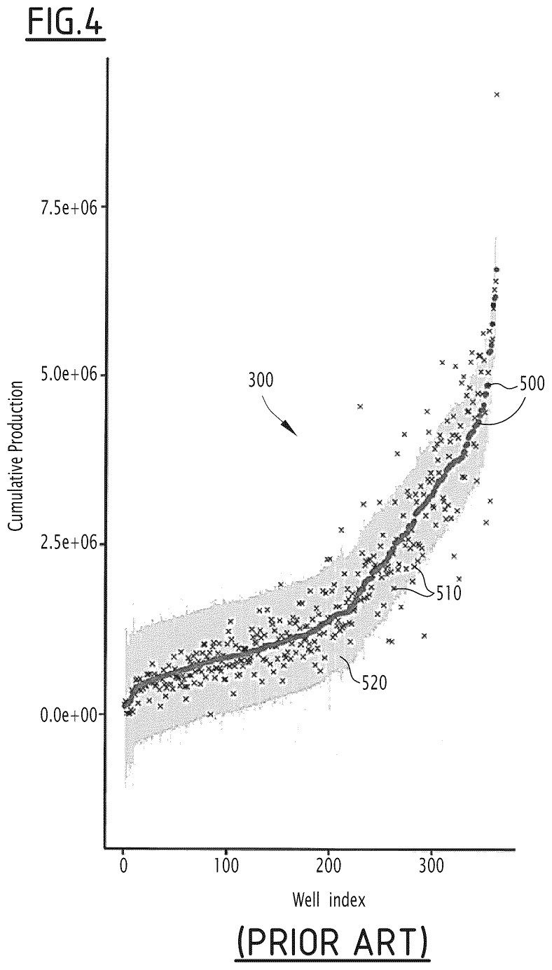

The results obtained with a prior art prediction method, such as a prediction method with a MLE standardized predictive distribution, are compared with the results obtained with the prediction method according to the invention in view of FIGS. 4 to 7.

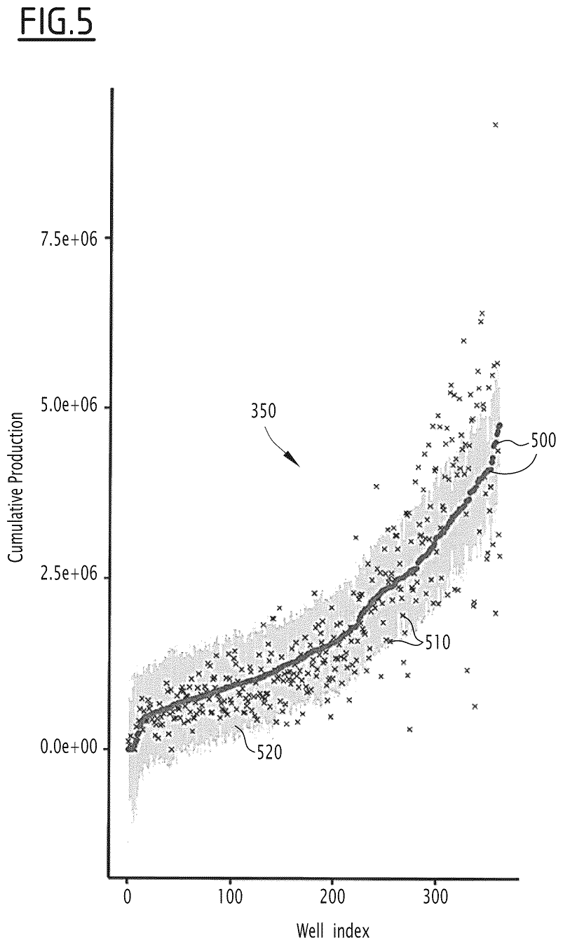

In FIGS. 4 and 5, the target device 15 is an oil and/or gas production well, and the quantity is a cumulated production over a predefined duration. In FIGS. 4 and 5, the ordinate therefore represents said cumulated production and the abscissa represents an index of the production well, also called well index. In FIGS. 4 and 5, the well indexes have been ordered with respect to their cumulated production.

In FIG. 4, a first set 300 shows the results obtained with the MLE standardized predictive distribution of the prior art; and in FIG. 5, a second set 350 shows the results obtained with the prediction method according to the invention.

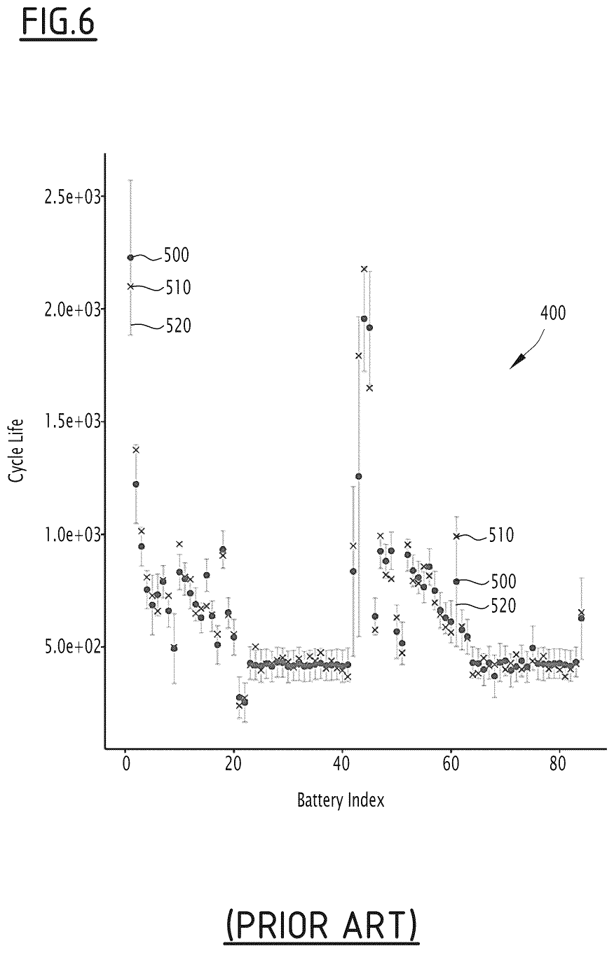

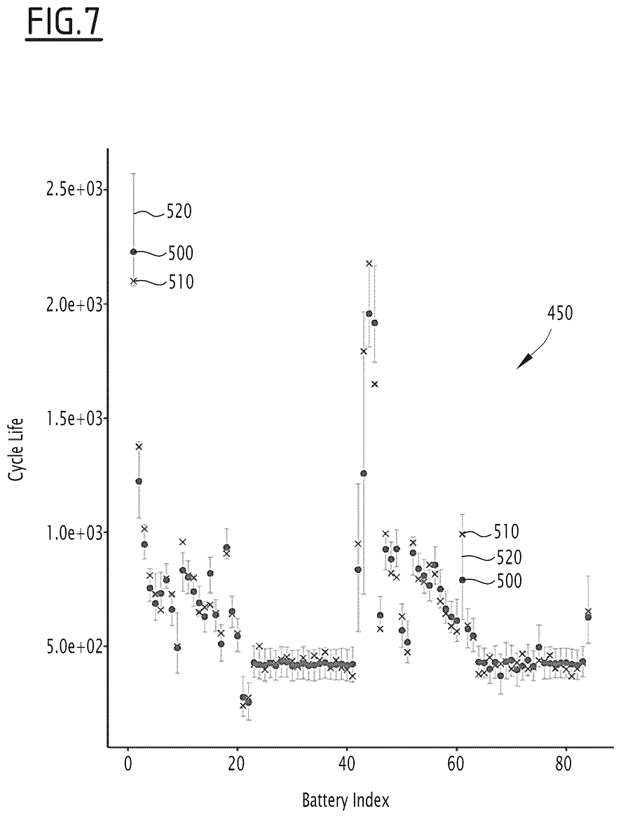

In FIGS. 6 and 7, the target device 15 is an electric battery and the quantity is a number of load cycles up to a predefined loss of battery capacity. In FIGS. 6 and 7, the ordinate therefore represents said number of load cycles up to a predefined loss of battery capacity, also called cycle life, and the abscissa represents an index of the battery, also called battery index.

In FIG. 6, a third set 400 shows the results obtained with the MLE standardized predictive distribution of the prior art; and in FIG. 7, a fourth set 400 shows the results obtained with the prediction method according to the invention.

In all sets 300, 350, 400, 450 shown in FIGS. 4 to 7, the predicted values of the quantity are represented by dots 500; true values, i.e. measured values, of said quantity are represented by crosses 510; and confidence intervals around the predicted values are represented as vertical segments 520.

In order to compare the prior art results with the invention results, a coverage probability is computed for each set among the first, second, third and fourth sets 300, 350, 400, 450. The coverage probability is typically defined in pages 2 and 3 of the article “Joint Estimation of Model and Observation Error Covariance Matrices in Data Assimilation: a Review” from P. Tandeo et al, published in 2018.

For the first set 300 and for a desired confidence level equal to 80%, the coverage probability on a training set is equal to 90.9% and then the coverage probability on a validation set is equal to 92.6%, with an accuracy equal to 0.88.

For the second set 350 and for the same desired confidence level equal to 80%, the coverage probability on the training set is equal to 79.9% and then the coverage probability on the validation set is equal to 81.3%, with an accuracy equal to 0.74.

The skilled person will therefore note that the accuracy is a little lower (−16%) with the prediction method according to invention than with the prediction method of the prior art, but that the desired confidence level of 80% is much more respected with the prediction method according to invention than with the prediction method of the prior art.

For the third set 400 and for a desired confidence level equal to 90%, the coverage probability on a training set is equal to 92.9% %, with an accuracy equal to 0.945.

For the fourth set 450 and for the same desired confidence level equal to 90%, the coverage probability on the training set is equal to 89.3%, with an accuracy equal to 0.945.

The skilled person will furthermore observe that in this example the accuracy is the same with the prediction method according to invention and with the prediction method of the prior art, but that the desired confidence level of 90% is again more respected with the prediction method according to invention than with the prediction method of the prior art.

Thus, by taking into account the predefined distribution quantile q_{A}, such as the A-quantile of the standard normal law, into the criteria used for optimizing the model parameter(s) of the prediction probabilistic model, the method according to the invention allows building a better prediction model capable of accurately predicting quantiles and of giving prediction intervals that incorporate the uncertainties of the data.

Therefore, the prediction method and the electronic prediction system 10 according to invention provide better prediction intervals.

1. A method predicting a value of a quantity relative to a target device, the method being implemented by an electronic prediction system and comprising the following steps:
training a prediction probabilistic model, said training including the following sub-steps:
receiving measured values of the quantity for N devices, N being an integer strictly greater than 1,
calculating predicted values of the quantity for said N devices with the prediction probabilistic model,
computing a criteria based on the measured values and on the predicted values,
modifying a model parameter of the prediction probabilistic model according to the computed criteria, and
updating the prediction probabilistic model with the modified model parameter, and
predicting a value of the quantity relative to the target device with the trained prediction probabilistic model;
wherein the criteria depends on a predefined distribution quantile.

2. The method according to claim 1, wherein the calculating sub-step is carried out according to a cross-validation process.

3. The method according to claim 2, wherein when the prediction probabilistic model is a model chosen among a Gaussian process model and a linear regression model, the predefined distribution quantile is the A-quantile of the standard normal law, A being a real number belonging to the interval [0; 1].

4. The method according to claim 2, wherein the cross-validation process is a Leave-One-Out Cross Validation process, and the criteria further depends on a Leave-One-Out mean of the predicted values and on a Leave-One-Out standard deviation of the predicted values.

5. The method according to claim 4, wherein
when the prediction probabilistic model is the Gaussian process model, the criteria verifies the following equation:
$${ψ}_{A} ( {σ}^{2} , θ ) = A$$
where A is a real number belonging to the interval [0; 1],
σ, θ represent the model parameters of the prediction probabilistic model, and
Ψ_{A} is a quasi-Gaussian proportion verifying the following equation:
$${ψ}_{A} ( {σ}^{2} , θ ) = \frac{1}{N} {\sum }_{k = 1}^{N} 𝕝 ( \frac{{y}_{k} -}{} \leq {q}_{A} )$$
where N represent the number of devices for which measured values of the quantity have been received, N being an integer strictly greater than 1, [symbol]
represents the indicator function indicating 1 if the inequality holds or 0 if not,
yₖ represent the measured values of the quantity, k being an index between 1 and N, [symbol]
and [symbol] represent respectively the Leave-One-Out mean of the predicted values and the Leave-One-Out standard deviation of the predicted values, and
q_{A} is the A-quantile of the standard normal law;
when the prediction probabilistic model is the linear regression model, the criteria verifies the following equation:
$${ψ}_{A} ( β ) = A$$
where A is a real number belonging to the interval [0; 1],
β represents the regression model's parameters, and
Ψ_{A} is a quasi-Gaussian proportion verifying the following equation:
$${ψ}_{A} ( β ) = \frac{1}{N} {\sum }_{k = 1}^{N} 𝕝 ( \frac{{y}_{k} -}{} \leq {q}_{A} )$$
where N represent the number of devices for which measured values of the quantity have been received, N being an integer strictly greater than 1, [symbol]
represents the indicator function indicating 1 if the inequality holds or 0 if not,
yₖ represent the measured values of the quantity, k being an index between 1 and N, [symbol]
and [symbol] represent respectively the Leave-One-Out mean of the predicted values and the Leave-One-Out standard deviation of the predicted values, and
q_{A} is the A-quantile of the standard normal law.

6. The method according to claim 1, wherein the training step further comprises a sub-step of determining a reference parameter of the prediction probabilistic model according to an error criteria.

7. The method according to claim 6, wherein the training step further comprises a sub-step of evaluating a distance between the reference parameter and the model parameter.

8. The method according to claim 7, wherein the training step further comprises a sub-step of minimizing said distance by solving a relaxed optimization problem.

9. The method according to claim 8, wherein the updating sub-step is carried out with the optimization parameter and the model parameters obtained further to the solved relaxed optimization problem.

10. The method according to claim 1, wherein each device is subject to aging, and the quantity depends of the age of the device.

11. The method according to claim 1, wherein the N devices are of the same type than the target device.

12. The method according to claim 1, wherein when each device is an oil and/or gas production well, the quantity is a production quantity,
when each device is an electric battery, the quantity is a number of load cycles up to a predefined loss of battery capacity, and
when each device is a dielectric insulation for an electric cable, the quantity is a dielectric rigidity.

13. The method for operating a device with predicted value(s) of a quantity relative to said device, the predicted value(s) being obtained with a prediction method according to claim 1.

14. Non-transitory computer-readable medium including a computer program including software instructions which, when executed by a processor, implement a method according to claim 1.

15. An electronic prediction system predicting a value of a quantity relative to a target device, the system comprising:
a training module configured for training a prediction probabilistic model, said training module including:
a receiving unit configured to receive measured values of the quantity for N devices, N being an integer strictly greater than 1,
a calculating unit configured to calculate predicted values of the quantity for said N devices with the prediction probabilistic model,
a computing unit configured to compute a criteria based on the measured values and on the predicted values,
a modifying unit configured to modify model parameter(s) of the prediction probabilistic model according to the computed criteria, and
an updating unit configured to update the prediction probabilistic model with the modified model parameter(s), and
a predicting module configured to predict the value of the quantity relative to the target device with the trained prediction probabilistic model;
wherein the criteria depends on a predefined distribution quantile.

16. The method according to claim 6, wherein the distance is the Wasserstein distance when the prediction probabilistic model is a Gaussian process model.

17. The method according to claim 6, wherein the distance is the Euclidean distance when the prediction probabilistic model is a linear regression model.

18. The method according to claim 8, wherein when the prediction probabilistic model is the Gaussian process model, the relaxed optimization problem verifies the following equation:
$${P}_{λ} : arg {min}_{λ} {Π}^{2} ( {K}_{0} , K ( {σ}_{A}^{2} ( λ ) , λ {θ}_{0} ) )$$
where λ is an optimization parameter,
π represents the Wasserstein distance,
K₀ represents a covariance matrix of the reference parameters, and
K represents a covariance matrix of the model parameters (σ_{A}, λθ₀) obtained according to the computed criteria;

19. The method according to claim 8, wherein when the prediction probabilistic model is the linear regression model, the relaxed optimization problem verifies the following equation:
$${P}_{λ} : arg {min}_{λ} {d}^{2} ( {β}_{0} , λ β )$$
where λ is an optimization parameter,
d represents the Euclidean distance,
β₀ represents the reference regression model's parameters, and
β represents the regression model's parameters obtained according to the computed criteria.

20. The method according to claim 10, wherein each device is of the type chosen from among the group consisting of: an oil and/or gas production well, an electric battery, a dielectric insulation for an electric cable.
